(19) United States
(12) Patent Application Publication
(10) Pub. No.: US 2002/0052521 A1
(43) Pub. Date: May 2, 2002

(54) Ifosfamide, analogues thereof and their preparation

(76) Inventors: Joseph John Brennan, Cork City (IE); William Paul Armstrong, Co. Antrim (GB)

Correspondence Address: SALIWANCHIK LLOYD & SALIWANCHIK, A PROFESSIONAL ASSOCIATION, 2421 N.W. 41ST STREET, SUITE A-1, GAINESVILLE, FL, 326066669

(21) Appl. No.: 09/906,026

(22) Filed: Jul. 13, 2001

Related U.S. Application Data
(63) Continuation of application No. 09/091,641, filed on Jun. 19, 1998, now abandoned.
Application No. 09/091,641 is a 371 of international application No. PCT/GB96/03157, filed on Dec. 19, 1997.

(30) Foreign Application Priority Data
Dec. 19, 1995 (GB) 9525891.9
Feb. 8, 1996 (GB) 9602519.2

(51) Int. Cl. C07F 9/547

(52) U.S. Cl. 558/75

(57) ABSTRACT

The present invention pertains to a compound of formula (I)

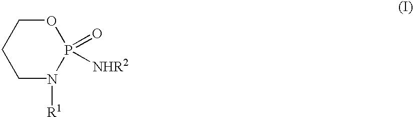

wherein R¹ and R² are each (CH₂)ₘX, each X is Cl or Br and m is 2 or 3, in combination with less than 0.5% w/w of the corresponding compound wherein R¹ is (CH₂)ₘH. Such compounds can be prepared by (i) the reaction of a Bronsted acid or a Lewis acid with NaBH₄ in an organic solvent, and (ii) adding the resultant solution to a solution of a corresponding compound wherein one of R¹ and R² is CO(CH₂)ₙX and the other is CO(CH₂)ₙX or (CH₂)ₘX, wherein n=m−1. Such compounds can also be prepared, in optically-enriched form, starting from an optically-enriched trihaloiminophosphorane of the formula R*N=Phal₃ wherein NR* is a chiral moiety derivable from a chiral amine or chiral sulphonamide of the formula R*NH₂, which can be cyclisable with HO(CH₂)₃NHR.

### FIELD OF THE INVENTION

This invention relates to processes for the preparation of ifosfamide and analogues thereof, and to the purified compounds themselves.

### BACKGROUND OF THE INVENTION

Compounds of formula (I)

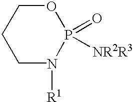

wherein two of R¹, R² and R³ are chloroalkyl groups, are potent anti-cancer drugs. Ifosfamide, i.e 3-(2-chloroethyl)-2-[(2-chloroethyl)amino]- 1,2,3-oxazaphosphorinane 2-oxide (I: R¹═R²═CH₂CH₂Cl, R³═H) has been found to elicit therapeutic response in human breast, ovarian and lung cancer. WO-A-9600075 and WO-A-9600076 disclose additional therapeutic benefit by the use of non-racemic ifosfamide. Cyclophosphamide (I: R¹═H, R²═R³═CH₂CH₂Cl) has similar effects.

Stec et al, Chem. Abs. (1984) 100 no. 5, abstract 034702 (see also PL-A-0119971), disclose the synthesis of ifosfamide by the reduction of phosphoramidate amide functions in compounds of formula I, wherein R¹ is COCH₂Cl, R² is CH₂CH₂Cl, and R³ is H, using diborane as a solution in THF (tetrahydrofuran). EP-A-0295576 discloses using the same starting material, but with borane generated in situ in the presence of substrate, using sodium borohydride and boron trifluoride etherate. WOA-9624600 (published after the priority dates of this Application) discloses a synthesis utilising borane generated in situ, sodium borohydride and conc. sulphuric acid.

The diborane process is reportedly low-yielding and inconsistent. From a process scale-up perspective, it is uneconomical.

Panckiewicz et al, JACS (1979) 101:7712, disclose a synthesis of optically-enriched ifosfamide and similar agents. This process has the problem that the chiral auxiliary, used in a stoichiometric amount, is necessarily destroyed in the process. This is undesirable, from a cost perspective.

### SUMMARY OF THE INVENTION

The present invention is based on our surprising discovery that the in situ processes generate a dechloro impurity (I: R¹═CH₂CH₃), at a level of 0.5-5.0%. This impurity can be removed, but 2-3 crystallisations are required to give ifosfamide in greater than 99.9% purity. A further discovery is that the level of dechloro impurity is a consequence of the length of exposure of the phosphoramidate and/or the product to sodium borohydride. According to this invention, ifosfamide and its analogues can be prepared in a form containing less than 0.5%, preferably less than 0.2%, and most preferably less than 0.1%, by weight of the dechloro impurity.

According to a first process aspect of the present invention, it has been found that pregeneration of borane using sodium borohydride and an acidic reagent, prior to contact with the substrate, is a more efficient system for the conversion of compounds of formula I, wherein R¹ is COCH₂Cl, and also of compounds where R² is COCH₂Cl. The acidic reagent may either be a Lewis acid (e.g. BF3. OEt₂) or a Bronsted acid (e.g. CF₃COOH or H₂SO₄).

A second process aspect of the present invention is based on the discovery that novel trichloroimino-phosporanes, derived from chiral amines, undergo cyclisation reactions with 3-amino-1-propanol and N-alkylated derivatives thereof, with useful levels of diastereoselectivity. The resultant products can then be converted to, say, optically-enriched ifosfamide, with recovery of the chiral amine. This and other discoveries can be readily utilised in preparing pure product, i.e. ifosfamide or an analogue thereof. Such analogues are defined in the claims (where substituents usually, unless otherwise defined, have up to 6, 8, 10 or 12 C atoms).

As a consequence of this invention, it is now possible to conduct a reproducible reduction procedure which gives non-racemic ifosfamide to a British Pharmacopoeia standard, thus allowing its formulation as a safe pharmaceutical drug. In particular, either enantiomer of ifosfamide or an analogue thereof can be produced, e.g. in at least 80 or 90% ee, substantially free of the dechioro impurity. The dechloro impurity can be detected using either gas chromatography or HPLC with the UV detector set at 195 mm for example.

### DESCRIPTION OF THE INVENTION

In the first novel process, the system generates borane in ethereal solvent at temperatures less than 10° C. This reducing system is then preferably used by being syphoned into an ethereal solution of the phosphoramidate amide to be reduced. This simple procedure, involving a new mode of addition, represents significant advantages over the prior art because the dechloro impurity is reduced sufficiently that multiple crystallisations are not required.

The novel optically-enriched trihaloiminophosphoranes used in the second process of the invention may be prepared by the Kirsanov reaction; see, for example, Kirsanov, Zh. Obshch. Khim. (1952) 22:269, and Johnston, in Ylides and Imines of Phosphorus, Ch. 13, pub. Wiley, N.Y. (1993). Thus, the reaction of phosphorus pentachloride and single enantiomer R*-NH₂, where R*-NH₂ is a chiral amine (e.g. 1-phenethylamine) or a chirl sulphonamide (e.g. 10-camphorsulphon-amide), gives optically-enriched trichloroiminophosphoranes. These compounds can be considered as chiral phosphorus oxychloride equivalents, and are useful intermediates for the preparation of the cytotoxic oxazaphosphorinanes such as ifosfamide and cyclophosphamide.

These reactions are depicted in Scheme 1; this shows by way of example the production of optically-enriched ifosfamide (* indicates the chiral center on P) and recovered auxiliary. The reactions shown in Scheme 1 are equally applicable to the preparation of the analogues of claims 9, 10 and 11; any modification that may be necessary will be readily apparent to one of ordinary skill in the art. The heterocyclic N atom may be unsubstituted or substituted, e.g. by a protecting group. Suitable protecting groups are well known to those of ordinary skill in the art, and can be introduced and removed by known procedures.

More specifically, reaction of the trichloroimino-phosphorane 1 with N-(2- chloroethyl)-3-amino-1-propanol propanol gives the key intermediate 2 for the synthesis of ifosfamide. Similarly, reaction of 1 with 3-amino-1-propanol gives the key intermediate in the synthesis of cyclophosphamide. Such conversions are synthetically useful since cyclisation products such as 2 are formed with appreciable levels of diastereoselectivity. Subsequent reaction of intermediate 2 with 2-chloroethylamine, followed by hydrolysis of the auxiliary, gives optically-enriched ifosfamide.

A preferred embodiment of the present invention is the use of carbonyl-containing auxiliaries such as 10-camphorsulphonamide, since at the end of the synthetic sequence these can be liberated and recovered by means of an intramolecular aza-Wittig reaction, followed by hydrolysis. More generally, the hydrolysis reaction may involve reacting the oxazaphosphorinane with a reagent that converts the P═NR* group to P═O, the essential reagent being H₂O or one that releases NR* as a product that is then hydrolysed to H₂NR*.

Where base is required in a process of the invention, any suitable base may be readily chosen by one of ordinary skill in the art. Examples are trialkylamines, N,N-disubstituted anilines and heterocyclic compounds which are basic, for example pyridine or imidazole.

Where a solvent is required in a process of the invention, any suitable solvent may be chosen by one of ordinary skill in the art. Examples are alkanes, aromatic hydrocarbons (e.g. toluene, xylene, etc), chlorinated solvents (such as dichloromethan), ethers and esters.

The following Examples illustrate the invention.

### EXAMPLE 1

To a suspension of NaBH₄ (0.83 g, 0.02 moles) in THF (30 ml) was added conc. H₂SO₄ (0.61 ml, 0.01 moles) dropwise at 5° C. under N₂ atmosphere. The reducing medium was syphoned under positive N₂ pressure into a stirred solution of 3(R)-chloroacetyl-2-(2-chloroethylamino)-1,3,2-oxazaphosphorinane 2-oxide (5.0 g, 0.018 moles) in THF (30 ml). After complete addition, the reaction was stirred at 5-10° C. for 1 hr, then allowed to warm to 20° C. over 2 hr. The reaction was quenched into water (35 ml) with vigorous stirring at 0° C. The resulting clear solution was stirred for 2 hr at 0-10° C. The THF was removed and the aqueous layer extracted with chloroform. The organics were dried, filtered and reduced to yield crude product (3.70 g, 78%). The crude (R)-ifosfamide was crystallised from methyl tert-butyl ether/heptane, with 90% recovery.

### EXAMPLE 2

The procedure of Example 1 was repeated with BF₃.OEt2 (2.63 ml, 0.02 moles) instead of conc. H₂SO₄. The crude product was isolated as a white solid (4.3 g, 91%) and crystallised from tert-butyl acetate/hexane, with 77% recovery.

### EXAMPLE 3 (S)-(α-Methylbenzyl)iminotrichlorophosphorane

(S)-α-Methylbenzylamine (2.42 g, 0.02 mol) was added over 5 min to a mechanically-stirred slurry of phosphorus pentachloride (4.16 g, 0.02 mol) in carbon tetrachloride (25 ml) over nitrogen. Heat was applied to bring the reaction to reflux, and the initially-formed precipitate began to go into solution. Reflux was maintained for 4 h, to remove all the hydrogen chloride, leaving a yellow-colored solution. The carbon tetrachloride was removed under reduced pressure, to leave a pale yellow oil which comprised fairly pure product (5.1 g, 95%). This crude material was distilled under reduced pressure, to give the product as a clear oil (b.p. 70-72° C. at 6×10⁻³ mm Hg).

### EXAMPLE 4 (1S)-(10-Camphorsulphonyl)iminotrichlorophosphorane

A mixture of (1S)-10-camphorsulfonamide (2.0 g, 8.66 mmol) and phosphorus pentachloride (1.8 g, 8.66 mmol) was refluxed in carbon tetrachIoride (25 ml) for 3 h. The resulting clear solution was evaporated at reduced pressure, to leave an oil which rapidly solidified to a white solid (3.2 g, 90%). This material was used without further purification.

### EXAMPLE 5 3-Benzyl-2-[N-(1S)-10-camphorsulfonylimino]-2-chlorotetrahydro-2H-1,2,3-oxazophorinane (RₚSₚ-diastereomeric mixture)

To a mechanically-stirred solution of the product of Example 4 (10.0 g, 27.2 mmol) in dry toluene (150 ml) at −10° C., under nitrogen, was added a mixture of N-benzyl-3-aminopropanol (4.5 g, 27.2 mmol) and triethylamine over 30 min. The reaction mixture was stirred vigorously and allowed to warm to room temperature over 4 h. It was filtered, and the toluene was then removed under reduced pressure at 50° C., to leave a pale yellow gum (13.2 g). ³¹P nmr analysis shows two diastereomer peaks around 8.43 (d.e. 52%). The oil was purified by flash chromatography on silica gel, using hexane/ethyl acetate, to give pure product as a mixture of diastereomers (d.e. 58%, 10.0 g, 80%).

### EXAMPLE 6 3-Benzyl-2-[N-(1S)-10-camphorsulfonylimino]-2-(2-chloroethylamino)tetrahydro-2H-1,3,2-oxazophosphorinane (RₚSₚ-diastereomeric mixture)

The product of Example 5 (2.0 g, 4.36 mmol, d.e. 58%) and 2-chloroethylamine hydrochloride (0.58 g, 5 mmol) were stirred in dry chloroform (60 ml) under nitrogen at room temperature. Triethylamine (1.39 ml, 10 mmol) was added over 5 min, and the mixture was then heated under reflux for 2 h. The reaction mixture was washed with water (100 ml) and brine (100 ml), and dried over sodium sulphate, and the solvent was removed in vacua to leave the product (2.01 g, 90%) as a pale yellow oil as a mixture of diastereomers (d.e. =50%).

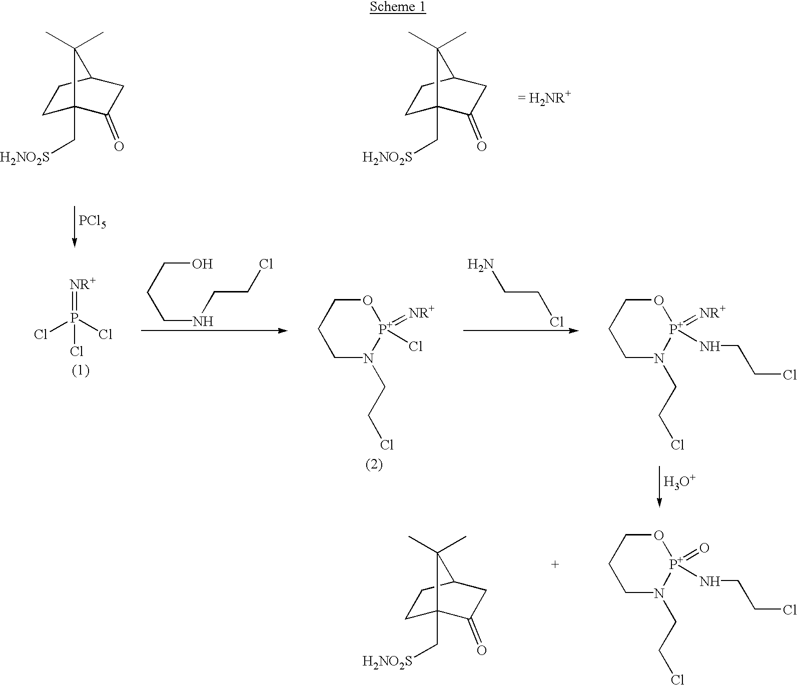

We claim

1. An enantiomerically-enriched compound of formula I 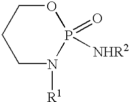
wherein R¹ and R² are each (CH₂)ₘX, each X is Cl or Br and m is 2 or 3, in combination with less than 0.5% w/w of the corresponding compound wherein R¹ is (CH₂)ₘH.

2. The compound according to claim 1, in admixture with less than 0.2% of said corresponding compound.

3. The compound according to claim 1, in admixture with less than 0.1% of said corresponding compound.

4. The compound according to claim 1, wherein m is 2.

5. The compound according to claim 4, which is ifosfamide.

6. The compound according to claim 1, wherein the enantiomeric excess is at least 80% ee.

7. A process for the preparation of a compound according to claim 1, which comprises (i) the reaction of a Bronsted acid or a Lewis acid with NaBH₄ in an organic solvent, and (ii) adding the resultant solution to a solution of a corresponding compound
wherein one of R¹ and R² is CO(CH₂)ₙX and the other is CO(CH₂)ₙX or (CH₂)ₘX, wherein n=m-1.

8. An enantiomerically-enriched trihaloiminophosphorane of the formula
R*N=Phal₃
wherein R* is a chiral moiety derivable from a chiral amine or chiral sulphonamide of the formula R*NH₂.

9. An enantiomerically-enriched halooxazaphosphorinane of the formula 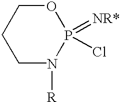
wherein R* is as defined in claim 8; and R is H, alkyl, haloalkyl, arylalkyl, acyl or haloacyl, or a protecting group.

10. An enantiomerically-enriched oxazaphosphorinane of the formula 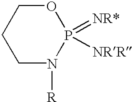
wherein R* is as defined in claim 8; R is as defined in claim 9; and R′ and R″ are independently H, haloalkyl, hydroxyalkyl or haloacyl.

11. The compound according to claim 9, wherein R and R′ are as defined for R¹ and R² in claim 1, and R″ is H.

12. A method for the preparation of enantiomerically-enriched ifosfamide or cyclophosphamide comprising the use of a compound selected from the group consisting of
a) an enantiomerically-enriched trihaloiminophosphorane of the formula
R*N=Phal₃
wherein R* is a chiral moiety derivable from a chiral amine or chiral sulphonamide of the formula R*NH₂;
b) an enantiomerically-enriched halooxazaphosphorinane of the formula 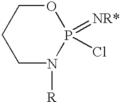
wherein R* is as defined in claim 8; and R is H, alkyl, haloalkyl, arylalkyl, acyl or haloacyl, or a protecting group; and
c) an enantiomerically-enriched oxazaphosphorinane of the formula 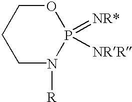
wherein R* is as defined in claim 8; R is as defined in claim 9; and R′ and R″ are independently H, haloalkyl, hydroxyalkyl or haloacyl.

13. A process for preparing a trihaloiminophosphorane according to claim 8, which 2 comprises the reaction of a phosphorus pentahalide with R*NH₂ in the presence of base, in an inert solvent.

14. A process for preparing a halooxazaphosphorinane of claim 9, which comprises the reaction of HO(CH₂)₃NHR with a trihaloiminophosphorane of claim 8, in the presence of a base, in an inert solvent.

15. A process for preparing an oxazaphosphorinane of claim 10, which comprises the reaction of a halooxazaphosphorinane of claim 9 with an amine HNR′R″ in the presence of a base, in an inert solvent.

16. A process for preparing a compound according to claim 1, which comprises the removal and recovery of the chiral auxiliary R*NH2 from an oxazaphosphorinane according to claim 10 and, if necessary, converting R to (CH₂)ₘX, and NR′R″ to NH—(CH₂)ₘX

17. The process according to claim 16, wherein removal of the chiral auxiliary comprises reaction with water under acidic or basic conditions.

18. The process according to claim 16, wherein removal of the chiral auxiliary comprises an aza-Wittig reaction.

19. The process according to claim 18, wherein the aza-Wittig reaction is an intramolecular process.

20. The process according to claim 19, which comprises using a carbonyl-containing reagent.

21. The compound of claim 10, wherein R and R′ are as defined for R¹ and R² in claim 1, and R″ is H.
